(19) United States
(12) Patent Application Publication
(10) Pub. No.: US 2025/0337209 A1
(43) Pub. Date: Oct. 30, 2025

(54) LASER CHAMBER DEVICE, GAS LASER APPARATUS, AND ELECTRONIC DEVICE MANUFACTURING METHOD

(71) Applicant: Gigaphoton Inc., Tochigi (JP)

(72) Inventor: Yoshiaki KUROSAWA, Oyama-shi (JP)

(73) Assignee: Gigaphoton Inc., Tochigi (JP)

(21) Appl. No.: 19/262,074

(22) Filed: Jul. 7, 2025

Related U.S. Application Data
(63) Continuation of application No. PCT/JP2023/004987, filed on Feb. 14, 2023.

(51) Int. Cl. H01S 3/036; H01S 3/038

(52) U.S. Cl. CPC H01S 3/036; H01S 3/038

(57) ABSTRACT

A laser chamber device according to one aspect of the present disclosure includes a magnetic coupling mechanism configured to transmit driving force to a rotating shaft of a fan that circulates laser gas, the magnetic coupling mechanism includes an inner rotor having a first magnet disposed thereon and an outer rotor having a second magnet disposed at a position facing the first magnet on an outer side of the inner rotor, and at least one of the first magnet and the second magnet is movable in a thrust direction of a bearing.

### CROSS-REFERENCE TO RELATED APPLICATIONS

The present application is a continuation application of International Application No. PCT/JP2023/004987, filed on Feb. 14, 2023, the entire contents of which are hereby incorporated by reference.

### 1. TECHNICAL FIELD

The present disclosure relates to a laser chamber device, a gas laser apparatus, and an electronic device manufacturing method.

### 2. RELATED ART

Recently, in a semiconductor exposure apparatus, improvement in resolution has been desired for miniaturization and high integration of semiconductor integrated circuits. For this purpose, an exposure light source that outputs light having a shorter wavelength has been developed. For example, as a gas laser apparatus for exposure, a KrF excimer laser apparatus that outputs a laser beam having a wavelength of about 248 nm and an ArF excimer laser apparatus that outputs a laser beam having a wavelength of about 193 nm are used.

Spectral linewidths of spontaneous oscillation light of the KrF excimer laser apparatus and the ArF excimer laser apparatus are as wide as from 350 μm to 400 μm. Therefore, when a projection lens is formed of a material that transmits ultraviolet light such as KrF and ArF laser beams, chromatic aberration may occur. As a result, the resolution may decrease. Thus, the spectral linewidth of the laser beam output from the gas laser apparatus needs to be narrowed to an extent that the chromatic aberration is ignorable. Therefore, in a laser resonator of the gas laser apparatus, a line narrowing module (LNM) including a line narrowing element (such as etalon or grating) may be provided in order to narrow the spectral linewidth. Hereinafter, a gas laser apparatus with a narrowed spectral linewidth is referred to as a line narrowing gas laser apparatus.

### LIST OF DOCUMENTS

### Patent Documents

Patent Document 1: Japanese Unexamined Patent Application Publication No. 2001-99194
Patent Document 2: Japanese Unexamined Patent Application Publication No. 2011-43194

### SUMMARY

A laser chamber device according to one aspect of the present disclosure includes a laser chamber, a fan, a bearing, and a magnetic coupling mechanism. The laser chamber houses laser gas. The fan is disposed inside the laser chamber and is configured to circulate the laser gas. The bearing is configured to rotatably support a rotating shaft of the fan. The magnetic coupling mechanism is configured to transmit driving force of a motor to the rotating shaft of the fan using magnetic force. The magnetic coupling mechanism includes an inner rotor connected to the rotating shaft of the fan and having a first magnet disposed thereon, and an outer rotor connected to a driving shaft of the motor, having a second magnet disposed at a position facing the first magnet on an outer side of the inner rotor, and configured to be rotated by the driving force of the motor and to cause the inner rotor to be rotated by magnetic attractive force. At least one of the first magnet and the second magnet is movable in a thrust direction of the bearing by the magnetic attractive force.

A gas laser apparatus according to one aspect of the present disclosure includes a laser chamber, a fan, a bearing, a motor, and a magnetic coupling mechanism. The laser chamber houses a discharge electrode and laser gas. The fan is disposed inside the laser chamber and is configured to circulate the laser gas. The bearing is configured to rotatably support a rotating shaft of the fan. The motor is configured to drive the fan. The magnetic coupling mechanism is configured to transmit driving force of the motor to the rotating shaft of the fan using magnetic force. The gas laser apparatus generates a laser beam by exciting the laser gas by discharge. The magnetic coupling mechanism includes an inner rotor connected to the rotating shaft of the fan and having a first magnet disposed thereon, and an outer rotor connected to a driving shaft of the motor, having a second magnet disposed at a position facing the first magnet on an outer side of the inner rotor, and configured to be rotated by the driving force of the motor and to cause the inner rotor to be rotated by magnetic attractive force. At least one of the first magnet and the second magnet is movable in a thrust direction of the bearing by the magnetic attractive force.

An electronic device manufacturing method according to one aspect of the present disclosure includes generating a laser beam with a gas laser apparatus, outputting the laser beam to an exposure apparatus, and exposing a photosensitive substrate to the laser beam within the exposure apparatus to manufacture an electronic device. The gas laser apparatus includes a laser chamber that houses a discharge electrode and laser gas, a fan disposed inside the laser chamber and configured to circulate the laser gas, a bearing configured to rotatably support a rotating shaft of the fan, a motor configured to drive the fan, and a magnetic coupling mechanism configured to transmit driving force of the motor to the rotating shaft of the fan using magnetic force, and the gas laser apparatus generates the laser beam by exciting the laser gas by discharge. The magnetic coupling mechanism includes an inner rotor connected to the rotating shaft of the fan and having a first magnet disposed thereon, and an outer rotor connected to a driving shaft of the motor, having a second magnet disposed at a position facing the first magnet on an outer side of the inner rotor, and configured to be rotated by the driving force of the motor and to cause the inner rotor to be rotated by magnetic attractive force, and at least one of the first magnet and the second magnet is movable in a thrust direction of the bearing by the magnetic attractive force.

### BRIEF DESCRIPTION OF THE DRAWINGS

Some embodiments of the present disclosure will be described below, by way of example only, with reference to the accompanying drawings.

FIG. 1 is a sectional view schematically illustrating a configuration of a gas laser apparatus according to a comparative example.

FIG. 2 is a sectional view schematically illustrating a configuration of a magnetic coupling mechanism of the comparative example.

FIG. 3 is a sectional view illustrating a cross section parallel to an axial direction of the magnetic coupling mechanism of the comparative example and a sectional view illustrating a cross section orthogonal to the axial direction.

FIG. 4 is a diagram explaining problems of the magnetic coupling mechanism of the comparative example.

FIG. 5 is a sectional view schematically illustrating a configuration of a magnetic coupling mechanism according to a first embodiment.

FIG. 6 is a diagram explaining an effect according to the first embodiment.

FIG. 7 is a sectional view illustrating Modification 1 of the first embodiment.

FIG. 8 is a diagram explaining an effect of Modification 1.

FIG. 9 is a sectional view illustrating Modification 2 of the first embodiment.

FIG. 10 is a sectional view schematically illustrating a configuration of a magnetic coupling mechanism according to a second embodiment.

FIG. 11 is a sectional view schematically illustrating a configuration of a magnetic coupling mechanism according to a third embodiment.

FIG. 12 is a diagram schematically illustrating an exemplary configuration of an exposure apparatus.

### DESCRIPTION OF EMBODIMENTS

### <Contents>

1. Comparative Example
   1.1 Configuration
      1.1.1 Configuration of Gas Laser Apparatus
      1.1.2 Configuration of Magnetic Coupling Mechanism and Bearing
         1.1.2.1 Configuration of Bearing
         1.1.2.2 Configuration of Magnetic Coupling Mechanism
   1.2 Operation
   1.3 Problem
2. First Embodiment
   2.1 Configuration
   2.2 Effect and Advantage
   2.3 Modifications of First Embodiment
      2.3.1 Modification 1
      2.3.2 Modification 2
3. Second Embodiment
   3.1 Configuration
   3.2 Effect and Advantage
4. Third Embodiment
5. Other Modifications
6. Electronic Device Manufacturing Method

Hereinafter, embodiments of the present disclosure will be described in detail with reference to the drawings. The embodiments described below show some examples of the present disclosure and do not limit contents of the present disclosure. In addition, all configurations and operations described in the embodiments are not necessarily essential as configurations and operations of the present disclosure. Here, the same components are denoted by the same reference signs, and any redundant description thereof is omitted.

### 1. Comparative Example

First, the comparative example of the present disclosure will be described. The comparative example of the present disclosure is an example recognized by the applicant as known only by the applicant, and is not a publicly known example admitted by the applicant.

### 1.1 Configuration

### 1.1.1 Configuration of Gas Laser Apparatus

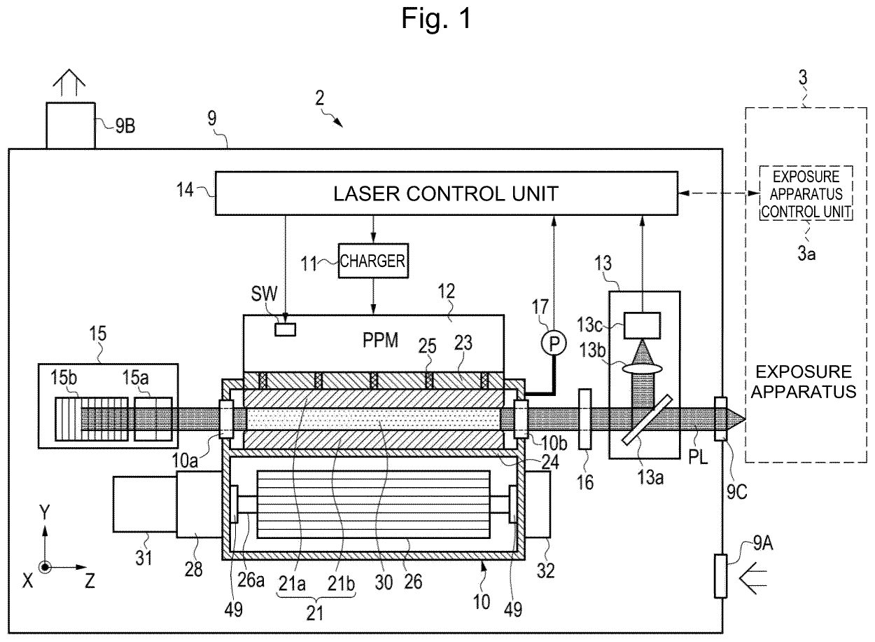

FIG. 1 schematically illustrates a configuration of a gas laser apparatus 2 according to the comparative example. The gas laser apparatus 2 is a laser beam source that generates a pulse laser beam PL. The pulse laser beam PL generated by the gas laser apparatus 2 is supplied to, for example, an exposure apparatus 3. The gas laser apparatus 2 is a discharge excitation type gas laser apparatus that excites laser gas by discharge, and is, for example, an excimer laser apparatus. For the laser gas, in addition to argon, krypton, xenon or the like may be used as rare gas, and fluorine, chlorine or the like may be used as halogen gas. As buffer gas, neon, helium, or mixed gas thereof, or the like is used.

In FIG. 1, a traveling direction of the pulse laser beam PL output from the gas laser apparatus 2 is defined as a Z direction. An X direction and a Y direction are orthogonal to each other, and an X-Y plane is orthogonal to the Z direction.

The gas laser apparatus 2 includes a housing 9, a laser chamber 10, a charger 11, a pulse power module (PPM) 12, a pulse energy measuring unit 13, a laser control unit 14, a pressure sensor 17, and a laser resonator.

The housing 9 houses components of the gas laser apparatus 2. The housing 9 is provided with an intake port 9A and an exhaust port 9B. The intake port 9A and the exhaust port 9B are ventilation ports used for ventilating the housing 9 and for introducing cooling gas from outside into the housing 9. Further, the housing 9 is provided with an exit window 9C that outputs the pulse laser beam PL toward the exposure apparatus 3.

The laser chamber 10 is, for example, a metal container formed of aluminum metal and plated with nickel on its surface, and the laser gas is sealed inside. As illustrated in FIG. 1, the laser chamber 10 houses a discharge electrode 21, an electrical insulation plate 23, a ground plate 24, and a fan 26.

The discharge electrode 21 is an electrode for exciting the laser gas by discharge. The discharge electrode 21 is formed of a pair of electrodes 21a and 21b, and the electrodes 21a and 21b are disposed to face each other with a predetermined gap and with their longitudinal directions being approximately parallel.

The electrical insulation plate 23 is disposed to cover an opening formed in the laser chamber 10. The electrical insulation plate 23 supports the electrode 21a. The electrical insulation plate 23 is embedded with a plurality of feedthroughs 25. The feedthroughs 25 electrically connect a high voltage terminal of the PPM 12 and the electrode 21a to apply a high voltage supplied from the PPM 12 to the electrode 21a.

The ground plate 24 supports the electrode 21b. The ground plate 24 is connected to the laser chamber 10 via wiring. The ground plate 24 is grounded to the ground via wiring. Ends of the ground plate 24 in the Z direction are fixed to the laser chamber 10.

The fan 26 is a cross-flow fan that circulates the laser gas in the laser chamber 10 to create a high-speed laser gas flow in a discharge space 30 between the electrodes 21a and 21b. The fan 26 is disposed so that the longitudinal direction of the discharge electrode 21 and the longitudinal direction of the fan 26 are approximately parallel.

A rotating shaft 26a of the fan 26 is rotatably supported at both ends by the laser chamber 10. A motor 31 that rotates the fan 26 via a magnetic coupling mechanism 28 is connected to the laser chamber 10. The magnetic coupling mechanism 28 transmits torque of the motor 31 to the rotating shaft 26a of the fan 26 using magnetic force, as will be described later.

The laser chamber 10 is provided with bearings 49 that rotatably support both ends of the rotating shaft 26a of the fan 26, respectively. Reference numeral 32 denotes a fixing part that fixes one of the bearings 49 to the laser chamber 10.

The charger 11 is a high voltage power supply that supplies a charging voltage to a charging capacitor included in the PPM 12. The PPM 12 includes a solid-state switch SW controlled by the laser control unit 14. When the solid-state switch SW is switched from OFF to ON, the PPM 12 generates a high voltage pulse from electric energy held in the charging capacitor and applies it to the discharge electrode 21.

When the high voltage is applied to the discharge electrode 21, discharge occurs between the electrodes 21a and 21b. By energy of the discharge, the laser gas in the laser chamber 10 is excited and shifts to a high energy level. When the excited laser gas then shifts to a low energy level, light having a wavelength corresponding to the energy level difference is discharged.

Windows 10a and 10b are provided on both ends of the laser chamber 10. The light generated in the laser chamber 10 is output to the outside of the laser chamber 10 through the windows 10a and 10b.

The laser resonator is formed of a line narrowing module (LNM) 15 and an output coupling mirror (Output Coupler: OC) 16.

The line narrowing module 15 includes a prism 15a and a grating 15b. The prism 15a expands a beam width of the light output from the laser chamber 10 through the window 10a and transmits the light to a side of the grating 15b.

The grating 15b is disposed in Littrow arrangement such that an incident angle and diffracting angle are the same angle. The grating 15b is a wavelength selection element that selectively extracts light near a specific wavelength according to the diffracting angle. A spectral width of the light returning from the grating 15b through the prism 15a to the laser chamber 10 is narrowed.

The output coupling mirror 16 transmits a part of the light output from the laser chamber 10 through the window 10b, and reflects the other part back to the laser chamber 10. A surface of the output coupling mirror 16 is coated with a partially reflective film.

The light output from the laser chamber 10 reciprocates between the line narrowing module 15 and the output coupling mirror 16, and is amplified every time of passing through the discharge space 30 between the electrodes 21a and 21b. A part of the amplified light is output as the pulse laser beam PL through the output coupling mirror 16. The pulse laser beam PL is an example of a “laser beam” according to technology of the present disclosure.

The pulse energy measuring unit 13 is disposed in an optical path of the pulse laser beam PL output through the output coupling mirror 16. The pulse energy measuring unit 13 includes a beam splitter 13a, a light condensing optical system 13b, and a photosensor 13c.

The beam splitter 13a transmits the pulse laser beam PL with a high transmittance and reflects the other part of the pulse laser beam PL toward the light condensing optical system 13b. The light condensing optical system 13b condenses the light reflected by the beam splitter 13a onto a light receiving surface of the photosensor 13c. The photosensor 13c measures pulse energy of the light condensed on the light receiving surface and outputs a measured value to the laser control unit 14.

The laser chamber 10 is provided with a laser gas supply device and a laser gas exhaust device, which are not illustrated. The laser gas supply device includes a valve and a flow rate control valve, and is connected to a gas cylinder containing the laser gas. The laser gas exhaust device includes a valve and an exhaust pump.

The pressure sensor 17 detects a gas pressure in the laser chamber 10 and outputs a detection value to the laser control unit 14.

The laser control unit 14 is a processor that transmits and receives various signals to/from an exposure apparatus control unit 3a provided in the exposure apparatus 3. For example, to the laser control unit 14, target pulse energy of the pulse laser beam PL output to the exposure apparatus 3, a trigger signal related to a target oscillation timing, and the like are transmitted from the exposure apparatus control unit 3a.

The laser control unit 14 generally controls operations of the components of the gas laser apparatus 2 based on the measured value of the pulse energy, the detection value of the gas pressure, and the like, in addition to the various signals transmitted from the exposure apparatus control unit 3a. For example, the laser control unit 14 determines the gas pressure of the laser gas in the laser chamber 10 based on the detection value of the gas pressure and the charging voltage of the charger 11. The laser control unit 14 controls the laser gas supply device and the laser gas exhaust device so as to attain a determined gas pressure.

### 1.1.2 Configuration of Magnetic Coupling Mechanism and Bearing

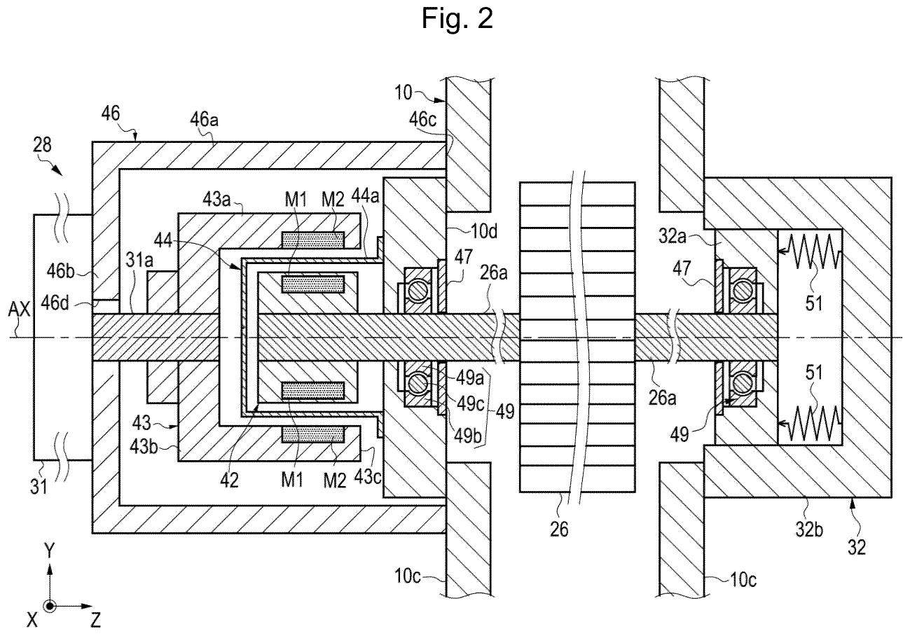

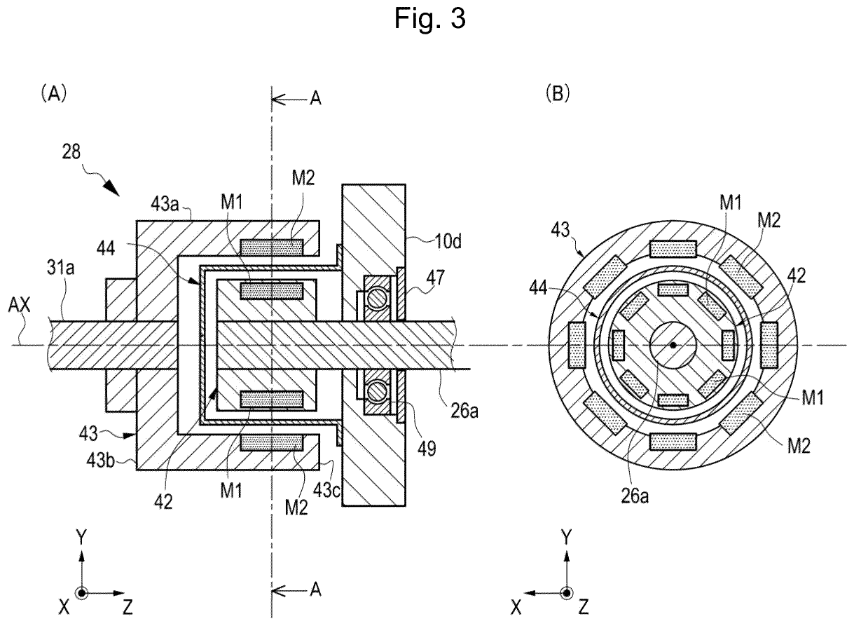

Using FIGS. 2 and 3, the magnetic coupling mechanism 28 and the bearing 49 according to the comparative example will be described. FIG. 2 is a sectional view of a Y-Z plane parallel to an axial direction AX of the rotating shaft 26a of the magnetic coupling mechanism 28. In FIG. 3, FIG. 3(A) is a sectional view of the Y-Z plane of the magnetic coupling mechanism 28, and FIG. 3(B) is a sectional view on a line A-A in FIG. 3(A). The sectional view on the line A-A is a sectional view of a Y-X plane that is orthogonal to the axial direction AX. Here, the axial direction AX is synonymous with a thrust direction of the bearing 49, and may also be referred to as the thrust direction below.

### 1.1.2.1 Configuration of Bearing

The bearing 49 is, for example, a ball bearing, and as is well known, includes an inner ring 49a fixed to the rotating shaft 26a, an outer ring 49b fixed to the laser chamber 10, and a plurality of rotating bodies 49c. A groove for housing the rotating bodies 49c is formed on an outer periphery of the inner ring 49a and on an inner periphery of the outer ring 49b, respectively. The rotating bodies 49c are held rotatably in a state where an inner side and an outer side are sandwiched between the inner ring 49a and the outer ring 49b. The rotating bodies 49c are, for example, spherical or cylindrical.

In addition, a seal member 47 is provided on an inner side of the laser chamber 10 with respect to the bearing 49. The seal member 47 has a donut shape with a hole to insert the rotating shaft 26a formed at a center. Between the hole of the seal member 47 and an outer peripheral surface of the rotating shaft 26a, a slight gap is formed to suppress contact of the seal member 47 and the rotating shaft 26a.

When the rotating shaft 26a is rotated, fine particles such as dust may be generated in the bearing 49, increasing a density of fine particles contained in the laser gas. The seal member 47 suppresses entry of the laser gas with the increased fine particle density to the inside of the laser chamber 10.

Of the two bearings 49, the bearing 49 on the side of the magnetic coupling mechanism 28 is fixed to a side wall 10c of the laser chamber 10 via a fixing part 10d, for example. The other bearing 49 is fixed to the side wall 10c of the laser chamber 10 via the fixing part 32. The fixing part 32 is formed of an attaching part 32a and a holding part 32b, for example. The attaching part 32a is a member to which the bearing 49 is attached. The holding part 32b holds the attaching part 32a and fixes the bearing 49 to the side wall 10c of the laser chamber 10 together with the attaching part 32a.

The holding part 32b has a cylindrical shape that can house the attaching part 32a inside, for example, and holds the attaching part 32a movably in the axial direction AX. Inside the holding part 32b, a spring 51 is provided. The spring 51 energizes the attaching part 32a toward the bearing 49 on the side of the magnetic coupling mechanism 28 in the axial direction AX. By offsetting the rotating shaft 26a with the spring 51, the rotating shaft 26a is stabilized.

Further, the holding part 32b also functions as a partition that prevents the laser gas from leaking to the outside of the holding part 32b.

### 1.1.2.2 Configuration of Magnetic Coupling Mechanism

The magnetic coupling mechanism 28 transmits driving force of the motor 31 to the rotating shaft 26a of the fan 26 using magnetic force. The magnetic coupling mechanism 28 includes an inner rotor 42, an outer rotor 43, a shroud 44, and a bracket 46.

The inner rotor 42 is connected to the rotating shaft 26a of the fan 26. The rotating shaft 26a partially protrudes from the laser chamber 10, and the inner rotor 42 is fixed to this protruding part. The inner rotor 42 has a circular cylindrical cross section that is orthogonal to the axial direction AX of the rotating shaft 26a, and includes an insertion part to which the rotating shaft 26a is to be inserted at the center. A plurality of first magnets M1 are disposed along an outer peripheral surface of the inner rotor 42. The first magnets M1 are permanent magnets and are disposed at equal intervals in a circumferential direction around the rotating shaft 26a. For the first magnets M1, N poles and S poles are alternately disposed in the circumferential direction. The inner rotor 42 is of an 8-pole type with eight first magnets M1, for an example. Positions of the first magnets M1 are fixed to the inner rotor 42.

The outer rotor 43 is rotated by the driving force of the motor 31 and causes the inner rotor 42 to be rotated by the magnetic force. The outer rotor 43 is connected to a driving shaft 31a of the motor 31. As illustrated with the axial direction AX, the driving shaft 31a of the motor 31 and the rotating shaft 26a of the fan 26, to which the inner rotor 42 is connected, are coaxially disposed. The outer rotor 43 has a cup-shaped container structure with a circular cylindrical cross section that is orthogonal to the driving shaft 31a.

More specifically, the outer rotor 43 includes a cylindrical part 43a that defines an internal space for housing the inner rotor 42. The cylindrical part 43a is bottomed, meaning that in the axial direction AX of the rotating shaft 26a, one end 43c on the side of the laser chamber 10 is open, and the other end on the side of the motor 31 has a bottom 43b.

At the bottom 43b, a fitting port to which the end of the driving shaft 31a on the side of the rotating shaft 26a is to be fitted is formed, and the driving shaft 31a is fixed in the fitting port. The outer rotor 43 is disposed with a gap between the end 43c and the fixing part 10d of the laser chamber 10.

An inner diameter of the cylindrical part 43a is larger than an outer diameter of the inner rotor 42. The outer rotor 43 houses the inner rotor 42 in the internal space so that an inner peripheral surface of the cylindrical part 43a and an outer peripheral surface of the inner rotor 42 face each other. In more detail, the inner rotor 42 is covered by the shroud 44 to be described later, and the cylindrical part 43a houses the inner rotor 42 in a state of being covered by the shroud 44.

A plurality of second magnets M2 are disposed along the inner peripheral surface of the cylindrical part 43a. The second magnets M2 are permanent magnets and are disposed at equal intervals in the circumferential direction around the rotating shaft 26a. For the second magnets M2, N poles and S poles are alternately disposed in the circumferential direction. The number of the second magnets M2 is the same as that of the first magnets M1, and each second magnet M2 is disposed to face the corresponding first magnet M1. The first magnets M1 and the second magnets M2 are disposed such that, when one of the opposing magnets is the N pole, the other is the S pole, generating attractive force between the opposing magnets. When the inner rotor 42 is of the 8-pole type, the outer rotor 43 is also of the 8-pole type with eight second magnets M2. Positions of the second magnets M2 are fixed to the outer rotor 43.

Further, lengths in the axial direction AX of the first magnets M1 and the second magnets M2, that is, sizes in the thrust direction, are the same, and the positions in the axial direction AX are determined so that the first magnets M1 and second magnets M2 face each other. In addition, the first magnets M1 and the second magnets M2 with different magnetic poles generate the attractive force in a radial direction centered around the rotating shaft 26a in the X-Y plane orthogonal to the rotating shaft 26a. A direction in which the attractive force is generated is also referred to as the radial direction hereinafter. The first magnets M1 and the second magnets M2 are disposed within a range where the attractive force acts on each other in the radial direction.

The bracket 46 is a fixing member for fixing the motor 31 to the laser chamber 10. The bracket 46 is fixed to the laser chamber 10 in a state of housing the outer rotor 43. The bracket 46 has a cup-shaped container structure with a circular cylindrical cross section that is orthogonal to the driving shaft 31a.

More specifically, the bracket 46 also has a bottomed cylindrical shape similarly to the outer rotor 43, and includes a cylindrical part 46a that houses the outer rotor 43. That is, for the cylindrical part 46a, in the axial direction AX, one end 46c on the side of the laser chamber 10 is open, and the other end on the side of the motor 31 has a bottom 46b.

An inner diameter of the cylindrical part 46a is larger than an outer diameter of the outer rotor 43. The cylindrical part 46a houses the outer rotor 43 in the internal space so that the inner peripheral surface and the outer peripheral surface of the outer rotor 43 face each other. The end 46c of the cylindrical part 46a on the side of the laser chamber 10 is fixed to the side wall 10c of the laser chamber 10.

An insertion port 46d is formed at the bottom 46b, to which the driving shaft 31a of the motor 31 is to be rotatably inserted. The motor 31 is fixed to an outer surface of the bottom 46b of the bracket 46 in a state where the driving shaft 31a is inserted to the insertion port 46d.

The shroud 44 houses the inner rotor 42. The laser gas inside the laser chamber 10 flows into the shroud 44. The shroud 44 functions as a partition that prevents the laser gas from leaking out to the outside of the shroud 44.

The shroud 44 has a cup-shaped container structure with a circular cylindrical cross section that is orthogonal to the rotating shaft 26a. More specifically, the shroud 44 has a cylindrical part 44a that defines the internal space for housing the inner rotor 42, and for the cylindrical part 44a, one end on the side of the side wall 10c is open, and an end on the side of the motor 31 is a bottom. The shroud 44 is fixed to the laser chamber 10 in a state where the open end of the cylindrical part 44a is in contact with the side wall 10c, and houses the inner rotor 42 in an airtight state.

The shroud 44 faces the first magnets M1 on an inner peripheral surface and faces the second magnets M2 on an outer peripheral surface. The shroud 44 is disposed in a state of being sandwiched between the first magnets M1 and the second magnets M2. A predetermined gap is provided between the outer peripheral surface of the cylindrical part 44a and the inner peripheral surface of the cylindrical part 43a of the outer rotor 43, and between the inner peripheral surface of the cylindrical part 44a and the outer peripheral surface of the inner rotor 42, respectively.

### 1.2 Operation

When the driving shaft 31a of the motor 31 is rotated, the outer rotor 43 connected to the driving shaft 31a is rotated. The second magnets M2 of the outer rotor 43 and the first magnets M1 of the inner rotor 42 generate magnetic attractive force in the radial direction, attracting each other. Therefore, when the outer rotor 43 is rotated, the inner rotor 42 is caused to be rotated by the magnetic attractive force. The magnetic poles that are the N poles and the S poles of the second magnets M2 and the first magnets M1 are alternately disposed in the circumferential direction, respectively. Therefore, for example, if a deviation in a rotational phase of the outer rotor 43 and the inner rotor 42, that is, a deviation in relative positional relationship between the second magnets M2 and the first magnets M1 in the circumferential direction, occurs and the magnets of the same pole face each other, magnetic repulsive force is generated. This repulsive force maintains the rotational phase of the outer rotor 43 and the inner rotor 42.

By the rotation of the inner rotor 42, the fan 26 is rotated. By the rotation of the fan 26, the laser gas is circulated within the laser chamber 10, creating the laser gas flow in the discharge space 30 of the discharge electrode 21.

The laser control unit 14 supplies a charging voltage corresponding to the target pulse energy received from the exposure apparatus 3 to the PPM 12 through the charger 11. When the trigger signal is input from the exposure apparatus 3, the laser control unit 14 applies a pulsed high voltage to the discharge electrode 21 through the PPM 12. When the high voltage is applied to the discharge electrode 21, the laser gas is excited, and a laser beam is output. The laser beam reciprocates between the line narrowing module 15 and the output coupling mirror 16, and the laser beam is amplified every time of passing through the discharge space 30. Further, the laser beam is narrowed by the line narrowing module 15, and the narrowed pulse laser beam PL is output from the output coupling mirror 16 towards the exposure apparatus 3.

Since the laser gas flow is created in the discharge space 30 by the rotation of the fan 26, excitation of the laser gas in the discharge space 30 is stabilized, and the stable pulse laser beam PL is supplied to the exposure apparatus 3.

### 1.3 Problem

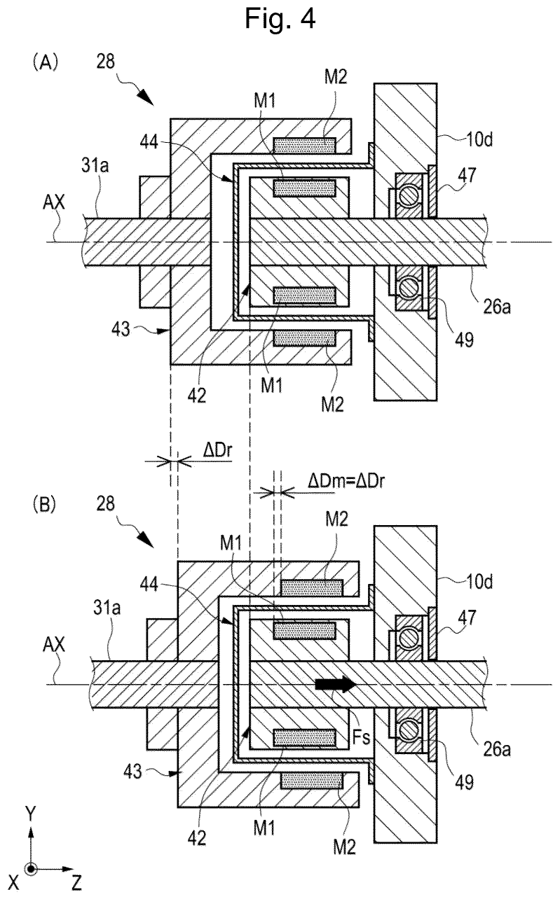

FIG. 4(A) illustrates an initial state of relative positional relationship in the axial direction AX, that is, in the thrust direction, between the inner rotor 42 and the outer rotor 43. In the initial state, only the attractive force in the radial direction is generated between the first magnets M1 and the second magnets M2, and no magnetic attractive force is generated in the thrust direction. More specifically, it is a state where centers in the thrust direction of the first magnets M1 and the second magnets M2 coincide.

FIG. 4(B) illustrates a case where there is a positional deviation ΔDr from the initial state in the relative positional relationship in the thrust direction between the inner rotor 42 and the outer rotor 43. The positional deviation ΔDr is caused by assembly errors during assembly of the magnetic coupling mechanism 28 and thermal expansion of parts due to heat generation and environmental temperature during the operation. FIG. 4(B) illustrates a state where the position of the outer rotor 43 is moved to the side of the laser chamber 10 by ΔDr from the state illustrated in FIG. 4(A).

The positions of the first magnets M1 are fixed to the inner rotor 42, and the positions of the second magnets M2 are fixed to the outer rotor 43. Therefore, when the positional deviation ΔDr occurs as illustrated in FIG. 4(B), a positional deviation ΔDm corresponding to ΔDr also occurs in the thrust direction of the first magnets M1 and the second magnets M2.

When the positional deviation ΔDm occurs, the first magnets M1 and the second magnets M2 generate force Fs in a direction of eliminating the positional deviation ΔDm by the magnetic attractive force. The force Fs is applied in the thrust direction of the bearing 49, and continues to be applied to the bearing 49 unless the positional deviation ΔDr between the inner rotor 42 and the outer rotor 43 is eliminated. The force Fs increases friction of the bearing 49 compared to the initial state illustrated in FIG. 4(A). The increase in friction has caused problems such as increased heat generation and noise of the bearing 49, and reduced service life of the bearing 49.

### 2. First Embodiment

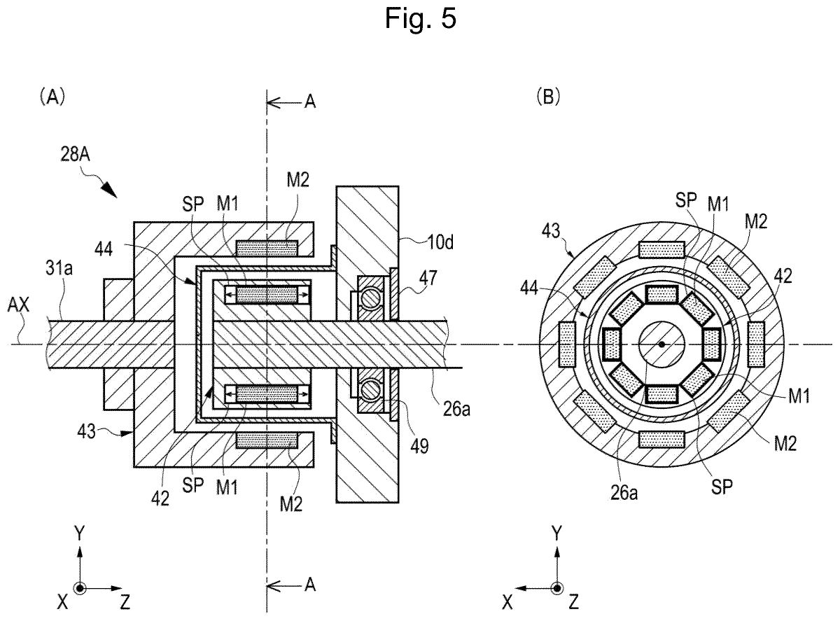

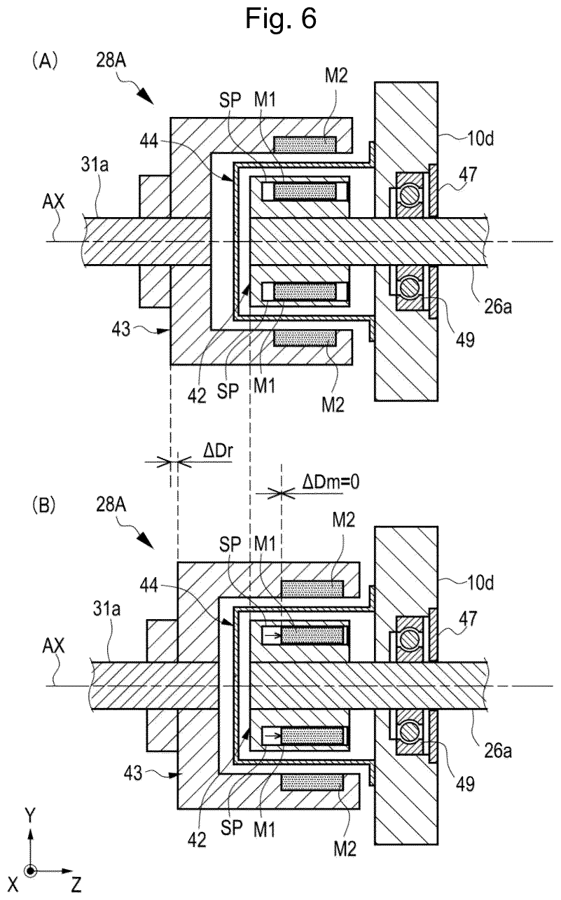

Next, with reference to FIGS. 5 and 6, a magnetic coupling mechanism 28A according to the first embodiment of the present disclosure will be described. In FIG. 5, FIG. 5(A) is a sectional view of the Y-Z plane of the magnetic coupling mechanism 28A, and FIG. 5(B) is a sectional view of the X-Y plane on a line A-A (see FIG. 5(A)) of the magnetic coupling mechanism 28A.

A gas laser apparatus including the magnetic coupling mechanism 28A of the first embodiment is similar to the gas laser apparatus 2 illustrated in the comparative example, except for the magnetic coupling mechanism 28A. The gas laser apparatus including the magnetic coupling mechanism 28A is an example of a “gas laser apparatus” according to the technology of the present disclosure. Moreover, a laser chamber device including the laser chamber 10, the fan 26, and the magnetic coupling mechanism 28A is an example of a “laser chamber device” according to the technology of the present disclosure.

The magnetic coupling mechanism 28A according to the first embodiment differs from the magnetic coupling mechanism 28 according to the comparative example in that the first magnets M1 are movable in the thrust direction relative to the inner rotor 42. Therefore, any components same as those described above are denoted by same signs, and any redundant description thereof is omitted unless specific description is needed.

### 2.1 Configuration

As illustrated in FIG. 5, in the magnetic coupling mechanism 28A, the first magnets M1 are movable in the thrust direction of the bearing 49 by the magnetic attractive force. In the first embodiment, housing chambers SP that house the first magnets M1 movably in the thrust direction are provided inside the inner rotor 42. The housing chamber SP is larger than the first magnet M1 in size in the thrust direction, that is, a length in the thrust direction. Therefore, the first magnet M1 is movable in the thrust direction inside the housing chamber SP.

As a specific size, the housing chamber SP is, for example, larger than the first magnet M1 in size in the thrust direction by a range of 1 mm to 4 mm. In addition, the housing chamber SP is, for example, larger than the first magnet M1 in size in the radial direction orthogonal to the thrust direction, that is, in thickness in the radial direction, by a range of 0.1 mm to 0.5 mm.

In the first embodiment, the second magnets M2 are fixed to the outer rotor 43, and the second magnets M2 are not movable in the thrust direction relative to the outer rotor 43. That is, of the first magnets M1 and the second magnets M2, only the first magnets M1 are movable in the thrust direction. Further, the sizes in the thrust direction of the first magnet M1 and the second magnet M2 are the same.

In addition, the inner rotor 42 that movably holds the first magnets M1 is formed of a non-magnetic material, for example. Further, the inner rotor 42 is formed of a corrosion-resistant material that is less likely to be corroded by fluorine gas. As a material of the inner rotor 42, for example, stainless steel such as SUS316 or SUS316L is used. The outer rotor 43 is formed of magnetic metal, for example, and a steel material such as SM490 is used.

### 2.2 Effect and Advantage

Using FIG. 6, the effect and the advantage of the magnetic coupling mechanism 28A of the first embodiment will be described. FIG. 6 corresponds to FIG. 4 of the comparative example, and FIG. 6(A) illustrates an initial state of the relative positional relationship in the thrust direction between the inner rotor 42 and the outer rotor 43 of the magnetic coupling mechanism 28A. In the initial state, there is no positional deviation ΔDr, the centers in the thrust direction of the first magnets M1 and the second magnets M2 coincide as well, and the magnetic attractive force is generated only in the radial direction. FIG. 6(B) illustrates a state where the positional deviation ΔDr occurs in the thrust direction between the inner rotor 42 and the outer rotor 43 due to assembly errors and thermal expansion or the like of the magnetic coupling mechanism 28A.

In the magnetic coupling mechanism 28A, the first magnets M1 are movable in the thrust direction by the magnetic attractive force. Therefore, as illustrated in FIG. 6(B), even if the positional deviation ΔDr occurs in the thrust direction of the inner rotor 42 and the outer rotor 43, the first magnets M1 move in the thrust direction, and the positional deviation ΔDm in the thrust direction between the first magnets M1 and the second magnets M2 is eliminated (indicated as ΔDm=0 in FIG. 6(B)). In other words, as illustrated in FIG. 6(B), the first magnets M1 move inside the housing chambers SP in a direction of eliminating the positional deviation ΔDm from the second magnets M2 by the magnetic attractive force with the second magnets M2. In FIG. 6(B), since the second magnets M2 move to the side of the laser chamber 10 along with the outer rotor 43, the first magnets M1 also move to the side of the laser chamber 10 by the magnetic attractive force.

In this way, in the magnetic coupling mechanism 28A, even if the positional deviation ΔDr occurs between the inner rotor 42 and the outer rotor 43, the positional deviation ΔDm is eliminated by the movement of the first magnets M1 in the thrust direction. As a result, the force Fs, as illustrated in FIG. 4(B) of the comparative example, is suppressed from being continuously applied to the bearing 49. This suppresses the increase in the friction of the bearing 49, thereby suppressing the heat generation, the noise, and the service life reduction of the bearing 49 due to the increase in the friction.

Moreover, since the inner rotor 42 is formed of a non-magnetic material, the inner rotor 42 is suppressed from being magnetized by the first magnets M1. When the inner rotor 42 is magnetized, magnetic attractive force is generated between the inner rotor 42 and the first magnets M1, and this becomes movement resistance of the first magnets M1. By forming the inner rotor 42 from a non-magnetic material, it is possible to suppress the movement resistance of the first magnets M1.

Further, since the inner rotor 42 is formed of a corrosion-resistant material that is less likely to be corroded by fluorine gas, it is possible to suppress corrosion caused by the laser gas leaking from the laser chamber 10 into the shroud 44.

In the first embodiment, even though the generation of the movement resistance of the second magnets M2 due to magnetization is not a problem since the second magnets M2 are fixed, the outer rotor 43 may be formed of a non-magnetic material instead of magnetic metal.

### 2.3 Modifications of First Embodiment

### 2.3.1 Modification 1

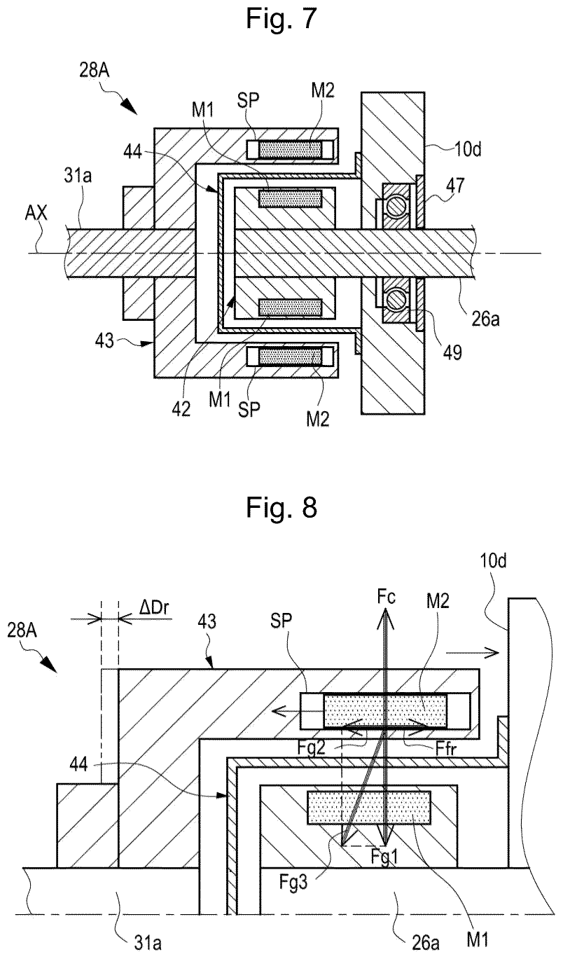

Modification 1 of the first embodiment illustrated in FIG. 7 is an example in which the second magnets M2 are movable in the thrust direction by the magnetic attractive force, instead of the first magnets M1. In the magnetic coupling mechanism 28A of Modification 1, housing chambers SP that house the second magnets M2 movably in the thrust direction are provided inside the outer rotor 43. In this way, even in a configuration that makes the second magnets M2 movable, the effect of suppressing the increase in the friction of the bearing 49 is obtained similarly to a case where the first magnets M1 are made movable.

Further, when the second magnets M2 are made movable, the outer rotor 43 is preferably formed of a non-magnetic material. This is because it can suppress the movement resistance of the second magnets M2 caused by the magnetization of the outer rotor 43.

Further, in the configuration that makes the second magnets M2 movable relative to the outer rotor 43 as in Modification 1, there are advantages that frictional force with an inner wall surface of the housing chamber SP when the second magnets M2 move is reduced and it becomes easier for the second magnets M2 to move, compared to the case illustrated in FIG. 6. Reasons are as follows.

As illustrated in FIG. 8, a case where the outer rotor 43 is moved to the side of the laser chamber 10 due to the thermal expansion or the like and the positional deviation ΔDr occurs is considered. In this case, the second magnet M2 moves in a direction of eliminating the positional deviation with respect to the first magnet M1, that is, in a direction opposite to the laser chamber 10. The magnetic attractive force generated in the second magnet M2 at this time can be decomposed into force Fg1 which is a radial direction component and force Fg2 which is a thrust direction component. Force Fg3 is resultant force of the force Fg1 and the force Fg2. To the second magnet M2, frictional force Ffr with the inner wall surface on the side of the first magnet M1 in the housing chamber SP is generated in a direction opposite to a moving direction of the second magnet M2, that is, in a direction opposite to the force Fg2 in the thrust direction. The frictional force Ffr becomes the movement resistance when the second magnet M2 moves in the thrust direction, and becomes larger as the force Fg1 in the radial direction becomes larger.

In addition, centrifugal force Fc is generated to the second magnet M2 by the rotation of the outer rotor 43. Since the centrifugal force Fc acts in a direction opposite to the force Fg1 in the radial direction acting on the second magnet M2, it reduces the frictional force Ffr. When the frictional force Ffr is reduced, the movement resistance of the second magnet M2 is reduced, making it easier for the second magnet M2 to move.

In contrast, when the first magnet M1 of the inner rotor 42 moves as illustrated in FIG. 6, since force in the radial direction by the magnetism acting on the first magnet M1 acts in a direction towards the second magnet M2 on the side of the outer rotor 43, the direction becomes the same as that of the centrifugal force acting on the first magnet M1. Therefore, the centrifugal force acting on the first magnet M1 results in increase in the frictional force. Thus, compared to the case illustrated in FIG. 6, Modification 1 illustrated in FIG. 8 is advantageous in terms of reducing the frictional force.

### 2.3.2 Modification 2

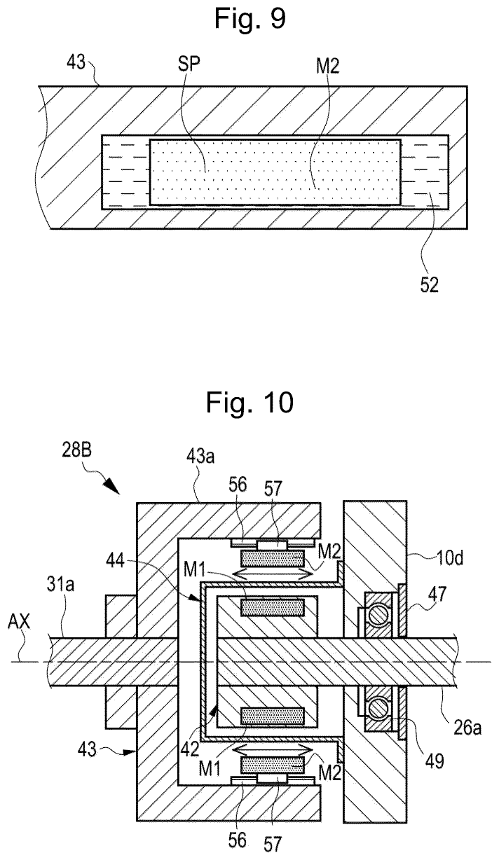

Modification 2 of the first embodiment illustrated in FIG. 9 is an example in which oil 52 is sealed in the housing chamber SP. FIG. 9 illustrates the housing chamber SP of the outer rotor 43, which houses the second magnet M2. Viscosity of the oil 52 is, for example, from ISO_VG10 to VG100. Since the inner wall surface of the housing chamber SP is lubricated with the oil 52, it is possible to reduce the movement resistance of the second magnet M2 moving inside the housing chamber SP compared to the case with no oil 52. In addition, the rapid movement of the second magnet M2 is suppressed by flow resistance of the oil 52, and the effect of reducing vibrations of the second magnet M2 inside the housing chamber SP can also be expected.

While FIG. 9 describes the housing chamber SP of the outer rotor 43 as an example, it may also be applied to the housing chamber SP of the inner rotor 42.

### 3. Second Embodiment

### 3.1 Configuration

As illustrated in FIG. 10, in a magnetic coupling mechanism 28B of the second embodiment, a moving mechanism that moves the second magnet M2 using a linear guide 56 and a carriage 57 is formed, instead of providing the housing chamber SP of the second magnet M2 inside the outer rotor 43. Since the magnetic coupling mechanism 28B is similar to Modification 1 of the first embodiment illustrated in FIG. 7 in other respects, differences will be mainly described.

The cylindrical part 43a of the outer rotor 43 is disposed on an outer periphery of the inner rotor 42. The linear guide 56 is provided on a position facing the inner peripheral surface of the cylindrical part 43a, that is, the outer peripheral surface of the inner rotor 42. The carriage 57 is held so as to be movable with respect to the linear guide 56 by being fitted with the linear guide 56. The second magnet M2 is fixed to the carriage 57 and moves together with the carriage 57. In this way, the linear guide 56 guides the movement of the second magnet M2 in the thrust direction via the carriage 57 and holds the second magnet M2.

In addition, in the magnetic coupling mechanism 28B, it is preferable that the linear guide 56 and the carriage 57, in addition to the outer rotor 43, are also formed of a non-magnetic material. By suppressing the magnetization of the linear guide 56 and the carriage 57, it is possible to suppress the movement resistance of the second magnet M2 by the magnetism.

### 3.2 Effect and Advantage

In the second embodiment, when the positional deviation ΔDr occurs between the inner rotor 42 and the outer rotor 43 (see FIG. 8 or the like), the second magnet M2 moves in the direction of eliminating the positional deviation from the first magnet M1 in the thrust direction. In the second embodiment, since the second magnet M2 is movably held by the linear guide 56, the movement resistance due to the friction is reduced compared to the case where the second magnet M2 is housed in the housing chamber SP.

While the second magnet M2 is held by the linear guide 56 via the carriage 57 in the second embodiment, the second magnet M2 may also be held directly by the linear guide 56 without the carriage 57. Needless to say, by providing the carriage 57, advantages such as ease of processing may be obtained. In that case, it is preferable to provide the carriage 57.

While FIG. 10 describes the second magnet M2 of the outer rotor 43 as an example, the linear guide 56 may be provided on the outer peripheral surface of the inner rotor 42 to hold the first magnet M1.

### 4. Third Embodiment

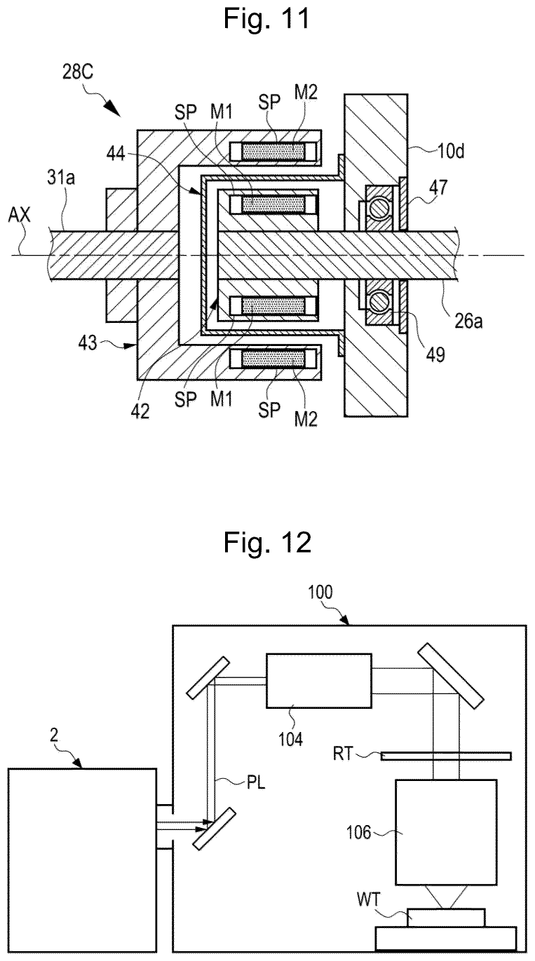

In a magnetic coupling mechanism 28C of the third embodiment illustrated in FIG. 11, both the first magnets M1 and the second magnets M2 are movable in the thrust direction by the magnetic attractive force. The inner rotor 42 and the outer rotor 43 are each provided with the housing chambers SP that movably house the first magnets M1 or the second magnets M2. The first magnets M1 and the second magnets M2 move in the thrust direction in their respective housing chambers SP.

In such a configuration as well, the first magnets M1 and the second magnets M2 move in the direction of eliminating the positional deviation ΔDm (see FIG. 6 or the like) so that it is possible to suppress the increase in the frictional force of the bearing 49 caused by the positional deviation ΔDr between the inner rotor 42 and the outer rotor 43 (see FIG. 6 or the like).

### 5. Other Modifications

While the gas laser apparatus 2 using the discharge electrode 21 according to the first and second embodiments is a line narrowing laser apparatus, without being limited thereto, it may be a gas laser apparatus that outputs spontaneous oscillation light. For example, instead of the line narrowing module 15, a high reflective mirror may be disposed.

In addition, while the gas laser apparatus 2 is an excimer laser apparatus in the embodiments, it may be alternatively an F2 molecular laser apparatus using laser gas containing fluorine gas and buffer gas. That is, the gas laser apparatus 2 according to the present disclosure may be a gas laser apparatus that excites laser gas containing fluorine by discharge.

### 6. Electronic Device Manufacturing Method

FIG. 12 schematically illustrates an exemplary configuration of an exposure apparatus 100. The exposure apparatus 100 includes an illumination optical system 104 and a projection optical system 106. The illumination optical system 104 illuminates a reticle pattern of a non-illustrated reticle disposed on a reticle stage RT with the pulse laser beam PL incident from the gas laser apparatus 2, for example. The projection optical system 106 performs reduced projection of the pulse laser beam PL transmitted through the reticle, and forms an image on a non-illustrated workpiece disposed on a workpiece table WT. The workpiece is a photosensitive substrate such as a semiconductor wafer on which photoresist is applied.

The exposure apparatus 100 synchronously translates the reticle stage RT and the workpiece table WT to expose the workpiece to the pulse laser beam PL reflecting the reticle pattern. A semiconductor device can be manufactured through a plurality of processes after the reticle pattern is transferred onto the semiconductor wafer through the exposure process as described above. The semiconductor device is an example of an “electronic device” in the present disclosure.

The gas laser apparatus 2 illustrated in FIG. 12 uses at least one of the magnetic coupling mechanisms 28A, 28B, and 28C according to the embodiments.

Note that the gas laser apparatus 2 may be used not only for manufacture of an electronic device but also for laser processing such as drilling.

The description above is intended to be illustrative and the present disclosure is not limited thereto. Therefore, it would be obvious to those skilled in the art that various modifications to the embodiments of the present disclosure would be possible without departing from the scope of the appended claims.

The terms used throughout the present specification and the appended claims should be interpreted as non-limiting terms. For example, terms such as “comprise”, “include”, “have”, and “contain” should not be interpreted to be exclusive of other structural elements. Further, indefinite articles “a/an” described in the present specification and the appended claims should be interpreted to mean “at least one” or “one or more.” Further, “at least one of A, B, and C” should be interpreted to mean any of A, B, C, A+B, A+C, B+C, and A+B+C as well as to include combinations of any thereof and any other than A, B, and C.

What is claimed is:

1. A laser chamber device comprising:
a laser chamber that houses laser gas;
a fan disposed inside the laser chamber and configured to circulate the laser gas;
a bearing configured to rotatably support a rotating shaft of the fan; and
a magnetic coupling mechanism configured to transmit driving force of a motor to the rotating shaft of the fan using magnetic force,
the magnetic coupling mechanism including
an inner rotor connected to the rotating shaft of the fan and having a first magnet disposed thereon, and
an outer rotor connected to a driving shaft of the motor, having a second magnet disposed at a position facing the first magnet on an outer side of the inner rotor, and configured to be rotated by the driving force of the motor and to cause the inner rotor to be rotated by magnetic attractive force, and
at least one of the first magnet and the second magnet being movable in a thrust direction of the bearing by the magnetic attractive force.

2. The laser chamber device according to claim 1, wherein
a housing chamber that houses the first magnet or the second magnet movably in the thrust direction is provided inside at least one of the inner rotor and the outer rotor.

3. The laser chamber device according to claim 2, wherein
the housing chamber is larger than the first magnet or the second magnet in size in the thrust direction by a range of 1 mm to 4 mm.

4. The laser chamber device according to claim 2, wherein
the housing chamber is larger than the first magnet or the second magnet in size in a radial direction orthogonal to the thrust direction by a range of 0.1 mm to 0.5 mm.

5. The laser chamber device according to claim 2, wherein
at least one of the inner rotor that movably holds the first magnet and the outer rotor that movably holds the second magnet is formed of a non-magnetic material.

6. The laser chamber device according to claim 2, wherein
oil is sealed in at least one of the housing chamber provided in the inner rotor and the housing chamber provided in the outer rotor.

7. The laser chamber device according to claim 6, wherein
viscosity of the oil is ISO_VG10 to VG100.

8. The laser chamber device according to claim 1, wherein
the outer rotor has a cylindrical part disposed on an outer periphery of the inner rotor, and
a linear guide configured to guide movement of the second magnet in the thrust direction and to hold the second magnet is provided on an inner peripheral surface of the cylindrical part.

9. The laser chamber device according to claim 8, wherein
the outer rotor and the linear guide are non-magnetic materials.

10. The laser chamber device according to claim 1, wherein
one of the first magnet and the second magnet is movable.

11. The laser chamber device according to claim 10, wherein
the second magnet is movable.

12. The laser chamber device according to claim 1, wherein
both the first magnet and the second magnet are movable.

13. The laser chamber device according to claim 1, wherein
the first magnet and the second magnet have a same size in the thrust direction.

14. A gas laser apparatus comprising:
a laser chamber that houses a discharge electrode and laser gas;
a fan disposed inside the laser chamber and configured to circulate the laser gas;
a bearing configured to rotatably support a rotating shaft of the fan;
a motor configured to drive the fan; and
a magnetic coupling mechanism configured to transmit driving force of the motor to the rotating shaft of the fan using magnetic force,
the gas laser apparatus generating a laser beam by exciting the laser gas by discharge,
the magnetic coupling mechanism including
an inner rotor connected to the rotating shaft of the fan and having a first magnet disposed thereon, and
an outer rotor connected to a driving shaft of the motor, having a second magnet disposed at a position facing the first magnet on an outer side of the inner rotor, and configured to be rotated by the driving force of the motor and to cause the inner rotor to be rotated by magnetic attractive force, and
at least one of the first magnet and the second magnet being movable in a thrust direction of the bearing by the magnetic attractive force.

15. An electronic device manufacturing method comprising:
generating a laser beam with a gas laser apparatus, the gas laser apparatus including
a laser chamber that houses a discharge electrode and laser gas,
a fan disposed inside the laser chamber and configured to circulate the laser gas,
a bearing configured to rotatably support a rotating shaft of the fan,
a motor configured to drive the fan, and
a magnetic coupling mechanism configured to transmit driving force of the motor to the rotating shaft of the fan using magnetic force,
the gas laser apparatus generating the laser beam by exciting the laser gas by discharge,
the magnetic coupling mechanism including
an inner rotor connected to the rotating shaft of the fan and having a first magnet disposed thereon, and
an outer rotor connected to a driving shaft of the motor, having a second magnet disposed at a position facing the first magnet on an outer side of the inner rotor, and configured to be rotated by the driving force of the motor and to cause the inner rotor to be rotated by magnetic attractive force, and
at least one of the first magnet and the second magnet being movable in a thrust direction of the bearing by the magnetic attractive force;
outputting the laser beam to an exposure apparatus; and
exposing a photosensitive substrate to the laser beam in the exposure apparatus to manufacture an electronic device.
